(19) United States
(12) Patent Application Publication
(10) Pub. No.: US 2016/0034256 A1
(43) Pub. Date: Feb. 4, 2016

(54) FAST INTEGER DIVISION

(71) Applicant: Imagination Technologies, Limited, Kings Langley (GB)

(72) Inventor: Leonard Rarick, San Diego, CA (US)

(21) Appl. No.: 14/449,850

(22) Filed: Aug. 1, 2014

(51) Int. Cl. G06F 7/535

(52) U.S. Cl. CPC G06F 7/535

(57) ABSTRACT

Embodiments disclosed pertain to apparatuses, systems, and methods for fast integer division. Disclosed embodiments pertain to an integer divide circuit to divide a dividend by a divisor and produce multiple quotient bits per iteration. In some embodiments, the fast integer divider may include a partial remainder register initialized with the dividend. Further, the fast integer divider circuit may include a plurality of adders, where each adder subtracts a multiple of the divisor from the current value in the partial remainder register. A logic block coupled to each of the adders, determines multiple quotient bits at each iteration based on the subtraction results.

### FIELD

The subject matter disclosed herein relates to processors, in general, and more specifically to integer division.

### BACKGROUND

Integer division is used in a variety of areas, including arithmetic logic units (ALUs) in processors, digital analog converters, etc. Conventional integer division techniques and circuits used with modern processors may exhibit either linear or quadratic convergence.

Typically, subtractive integer division (e.g. restoring, non-restoring, and Sweeney Robertson and Tocher (SRT) division), which converges linearly, is relatively slow because execution time varies linearly with quotient size. On the other hand, faster quadratically convergent Newton-Raphson and Goldschmidt integer division exhibit significantly greater overhead and initial setup time. For example, each iteration of a quadratically convergent technique may take significantly longer than an iteration in a linearly convergent integer division.

Therefore, in some instances, the use of linearly convergent fast integer division may be advantageous.

### SUMMARY

Disclosed embodiments pertain to an integer divide circuit to divide a dividend by a divisor (D) and produce m quotient bits per iteration, where m≧2. In some embodiments, the circuit may comprise: a partial remainder register, initialized with the dividend, to hold a current partial remainder (R); a plurality of 2^{m}−1 adders coupled to the partial remainder register, each adder i to output a corresponding subtraction result R−i*D, where 1≦i<2^{m}−1; and a logic block coupled to the 2^{m}−1 adders, wherein, the logic block determines m quotient bits based, at least in part, on the 2^{m}−1 subtraction results.

In another aspect, a processor may comprise an integer divide unit to produce m quotient bits per iteration, where m≧2. In some embodiments, the integer divide unit may further comprise: a partial remainder register, initialized with a dividend, to hold a current partial remainder (R); a plurality of 2^{m}−1 adders coupled to the partial remainder register, each adder i to output a corresponding subtraction result R−i*D, where D is the divisor and 1≦i≦2^{m}−1; and a logic block coupled to the adders, wherein, the logic block determines m quotient bits based, at least in part, on the 2^{m}−1 subtraction results.

In a further aspect, a non-transitory computer-readable medium may comprise executable instructions to describe an integer divide circuit to divide a dividend by a divisor (D) and produce m quotient bits per iteration, where m≧2. The integer divide circuit described above using executable instructions on the computer-readable medium may comprise: a partial remainder register, initialized with the dividend, to hold a current partial remainder (R); a plurality of 2^{m}−1 adders coupled to the partial remainder register, each adder i to output a corresponding subtraction result R−i*D, where 1≦i≦2^{m}−1; and a logic block coupled to the 2^{m}−1 adders, wherein, the logic block determines m quotient bits based, at least in part, on the 2^{m}−1 subtraction results.

The disclosure also pertains to circuits, processors, apparatuses, systems, and computer-readable media embodying instructions that describe the above embodiments.

### BRIEF DESCRIPTION OF THE DRAWINGS

FIG. 1 shows a schematic block diagram illustrating certain exemplary features of a computer system including a processor capable of performing fast integer division.

FIG. 2 shows a flowchart of a conventional method for restoring integer division.

FIG. 3A shows an exemplary circuit consistent with disclosed embodiments for implementing fast restoring integer division.

FIG. 3B shows a table illustrating the logic associated with block 340 shown in the exemplary circuit in FIG. 3A.

FIG. 3C shows an exemplary circuit consistent with disclosed embodiments to implement the logic in FIG. 3B.

FIG. 4A shows an exemplary circuit, consistent with disclosed embodiments for implementing fast restoring integer division.

FIG. 4B shows a table illustrating the logic associated with block 440 shown in the exemplary circuit in FIG. 4A.

FIG. 4C shows an exemplary circuit consistent with disclosed embodiments to implement the logic in FIG. 4B.

### DETAILED DESCRIPTION

The detailed description set forth below in connection with the appended drawings is intended as a description of some exemplary non-limiting embodiments and various other embodiments may be practiced and are envisaged as would be apparent to one of skill in the art. Embodiments described are provided merely as examples or illustrations of the present disclosure. The detailed description includes specific details for the purpose of providing a thorough understanding of the present disclosure. However, it will be apparent to those skilled in the art that the present disclosure may be practiced without one or more of these specific details. In some instances, well-known structures and devices are not shown in block diagram form in order to avoid obscuring the concepts of the present disclosure. Acronyms and other descriptive terminology may be used merely for convenience and clarity and are not intended to limit the scope of the disclosure. In general, disclosed embodiments may be implemented using some combination of hardware, firmware, and software.

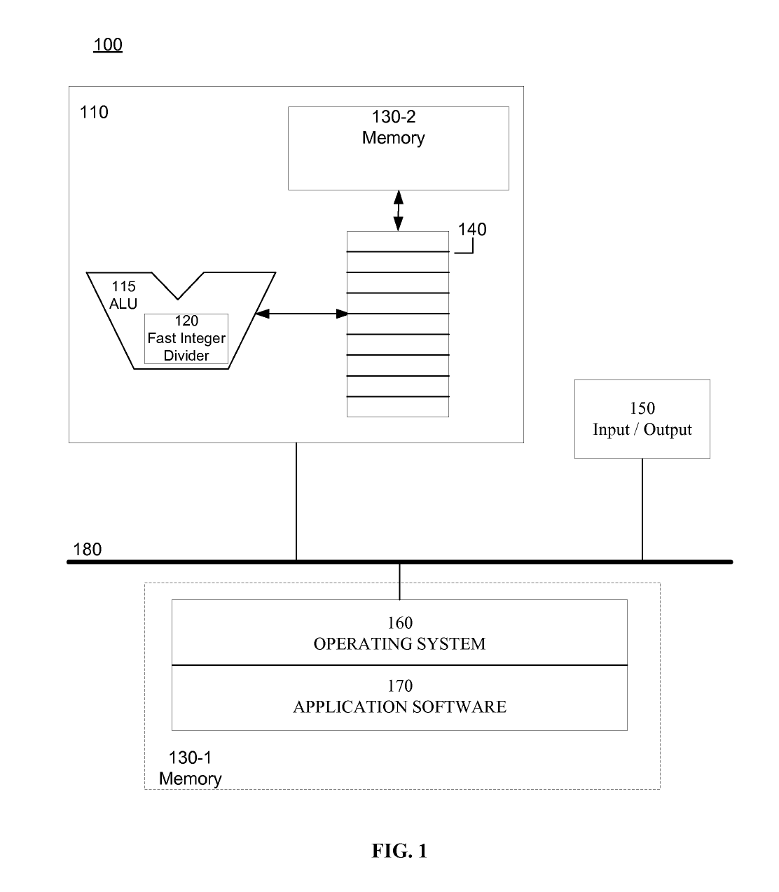

FIG. 1 shows a simplified schematic block diagram illustrating certain exemplary features of a computer system 100 including a processor 110 capable of performing fast integer division. As shown in FIG. 1, computer system 100 may further include Input-Output (I/O) devices such as a keyboard, mouse, touchscreens, pens, displays, speakers, sensors, multi-media devices, printers etc. Processor 110, I/O devices 150 and other system components may be coupled using bus 180. Memory 130-1 may also be coupled to the bus 180. Memory 180 may store operating system 160 and application software 170.

In some embodiments, processor 110 may include Arithmetic Logic Unit 115 and register file 120, and memory 130-2. In general, processor 110 may comprise several additional functional units, such as additional ALUs, which may include integer/floating point units, external bus interface units, clock, pipelined execution units, scheduling units, clocks, and/or other support logic. Many of these functional units have been omitted in FIG. 1 merely to simplify discussion. Processor 110 may be incorporated in a variety of electrical, electronic or electro-mechanical devices along with one or more additional components.

Processor 110 may be implemented using a combination of hardware, firmware, and software. In general, processor 110 may represent one or more circuits configurable to perform computations, including fast integer division in a manner consistent with disclosed embodiments. Processor 110 may be implemented within one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, embedded processor cores, integrated circuits, electronic devices, other electronic units designed to perform the functions described herein, or a combination thereof. In some embodiments, portions of techniques disclosed herein may also be implemented using firmware and/or software.

As used herein, the term “memory” is used to refer to any type of long term, short term, volatile, nonvolatile, or other memory and is not to be limited to any particular type of memory or number of memories, or type of physical media upon which memory is stored. In some embodiments, memories 130-1 and 130-2 (collectively referred to as memory 130) may hold instructions and/or data to facilitate operations performed by processor 100. For example, instructions/data may be loaded into register file 120 from memory 130 for use by ALU 115. For example, the instructions received may pertain to a fast integer division operation executed by ALU 115 and the results of the operation may be stored in register file 120 and in memory 130. In general, memory 130 may represent any data storage mechanism.

In some embodiments, memory 130 may include a hierarchy of memories, such as, for example, a primary memory and/or a secondary memory. Primary memory may include, for example, a random access memory, read only memory, etc.

Secondary memory may include, for example, the same or similar type of memory as primary memory and/or one or more data storage devices or systems, such as, for example, flash/USB memory drives, memory card drives, disk drives, optical disc drives, tape drives, solid state memory drives, etc.

Memory 130 may include a hierarchy of cache memories. For example, memory 130 may include an instruction and/or data cache. In some embodiments, memory 130 may also include a Read Only Memory (ROM) or other non-volatile memory, which may be used to store microcode to facilitate performance of one or more operations by processor 110.

In some embodiments, ALU 115 may include fast integer divider 120, which may be used to perform fast integer division in a manner consistent with disclosed embodiments. In some embodiments, some portion of fast integer divider 120 may be implemented using microcode.

In certain implementations, secondary memory may be operatively receptive of, or otherwise configurable to couple to a computer-readable medium in a removable media drive (not shown in FIG. 1) coupled to processor 110. In some embodiments, the computer-readable medium may comprise instructions that describe a processor and/or a fast integer divider. For example, the descriptions may be provided in a hardware description language such as VHDL, Verilog, or any other hardware description language.

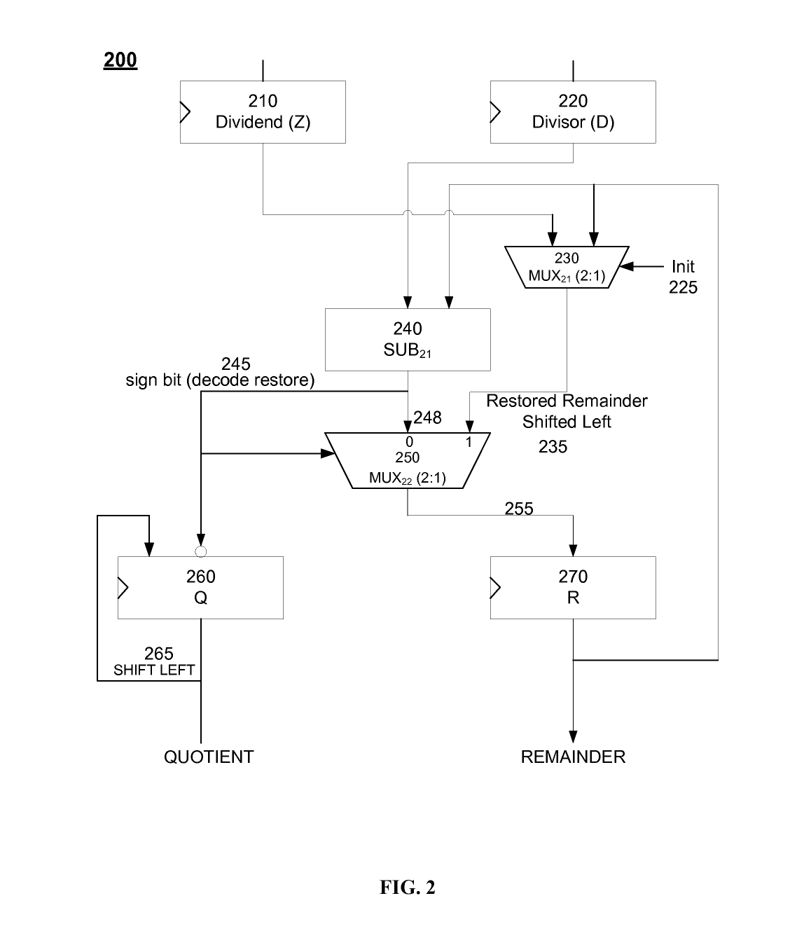

FIG. 2 shows a conventional circuit 200 for implementing restoring integer division. As shown in FIG. 2, the dividend and divisor may be held initially in dividend register Z 210 and divisor register D 220, respectively.

In circuit 200, 2:1 multiplexer MUX₂₁ 230 is coupled to dividend register Z 210, and to register R 270, which holds the current partial remainder. Select signal Init 225 may be used to select between the dividend input Z 210 and the current partial remainder R 270 which are input to MUX₂₁ 230. During initialization, select signal Init 225 may be set to select dividend Z 210 in multiplexer MUX₂₁ 230 so that dividend Z 210 is output from MUX₂₁ 230.

During initialization, Dividend Z 210, which is output by MUX₂₁ 230, is fed unshifted (bypassing any shift logic) to MUX₂₂ 250. During initialization, the select signal of MUX₂₂ 250 may be configured to select input “1” in MUX₂₂ 250. Thus, output 255 of MUX₂₂ 250, representing dividend Z 210, is loaded into current partial remainder register R 270, thereby initializing current partial remainder register R 270 with the contents of dividend register Z 210.

Accordingly, after initialization current partial remainder register R 270 may hold the dividend, divisor register D 220 may hold the divisor, and quotient register Q 260 may be initialized to zero.

After initialization, 2:1 multiplexer MUX₂₁ 230 may be configured to select current partial remainder register R 270. The output of multiplexer MUX₂₁ 230, which represents the value in current partial remainder register R 270, may then be left shifted to obtain restored remainder shifted left 235, which is input to MUX₂₂ 250.

Further, in circuit 200, divisor register D 220 and current partial remainder register R 270 are coupled to subtractor SUB₂₁ 240, which may subtract D 220 from R 270. Divisor D 220 is subtracted from current partial remainder R 270 to obtain subtraction result 248. Sign bit 245 of subtraction result 248 may be used to determine if the result was non-negative (sign bit=0) or negative (sign bit=1). Sign bit 245 may be used to select one of subtraction result 248 when subtraction result 248 is non-negative (sign bit=0) or restored remainder shifted left 235 when subtraction result 248 is negative (sign bit=1).

When the result of subtracting divisor D 220 from current partial remainder R 270 is non-negative (sign bit=0), the output of MUX₂₂ 250 reflects subtraction result 248, which is stored in current partial remainder register R 270.

When the result of subtracting divisor D 220 from current partial remainder R 270 is negative (sign bit=1), the sign bit selects restored remainder shifted left 235, which forms output 255 of MUX₂₂ 250 and the new value of current partial remainder register R 270.

Sign bit 245 is inverted and fed to register Q 260, which is shifted left each iteration. Thus, when the result of subtracting divisor D 220 from current partial remainder R 270 is non-negative (sign bit=0), the current quotient bit is 1; whereas when the result of subtracting divisor D 220 from current partial remainder R 270 is negative (sign bit=1), the current quotient bit is 0.

A counter may be used to determine the number of iterations needed and to determine when the division is complete. At the end of the division, register Q 260 holds the quotient and register R 270 the final remainder.

Thus, conventional circuit 200 produces 1 quotient bit per iteration. In many situations, the performance of conventional circuits like circuit 200 may be less than optimal. Accordingly, various other techniques such as SRT divides have been used to speed up integer division. SRT divides have larger overheads for setup and resolving the final result. Although typical SRT divide implementations provide 1 quotient bit per clock, SRT divides are often used because they use a redundant number representation that does not have a long carry propagation for addition. Thus, when the clock speed is high enough that the carry look ahead adder 240 and multiplexer 250 cannot be carried out in one clock, then, SRT may offer advantages even when 1 quotient bit per clock is provided. However, typically, for smaller integer divides the carry propagate in carry look ahead adder 240 is short enough that adder 240 and multiplexer 250 can be completed in one clock. Therefore, for smaller integer divides, 1 quotient bit per clock SRT is always slower than restoring divide and even a 2 quotient bit per clock SRT may be slower due to the larger overhead cost, which is now amortized over a smaller number of iterations. Thus, in many instances, such as for example, for smaller integer divides, SRT may fail to deliver significant performance improvements relative to circuit 200.

Further, while non-restoring integer division circuits are available, they are not significantly faster. Typically, conventional non-restoring integer division circuits use a carry look ahead adder/subtractor, logic, fan out to adder width, and an XOR gate while producing one quotient bit per cycle. Because XOR gates (such as those used in non-restoring integer division circuits) and multiplexers (such as those used in restoring integer division circuit 200) take similar processing times, no significant advantage is obtained by using conventional non-restoring integer division circuits relative to conventional integer division circuits (e.g. circuit 200).

Therefore, techniques disclosed herein facilitate fast integer division, in part, by obtaining multiple quotient bits per iteration.

The disclosed embodiments include an integer divide circuit to divide a dividend by a divisor and produce multiple quotient bits per iteration. In some embodiments, the integer divider may include a partial remainder register initialized with the dividend. The fast integer divider may also include a plurality of adders, where each adder subtracts a multiple of the divisor from the current value in the partial remainder register. A logic block coupled to each of the adders, determines multiple quotient bits at each iteration based on the subtraction results produced by the plurality of adders.

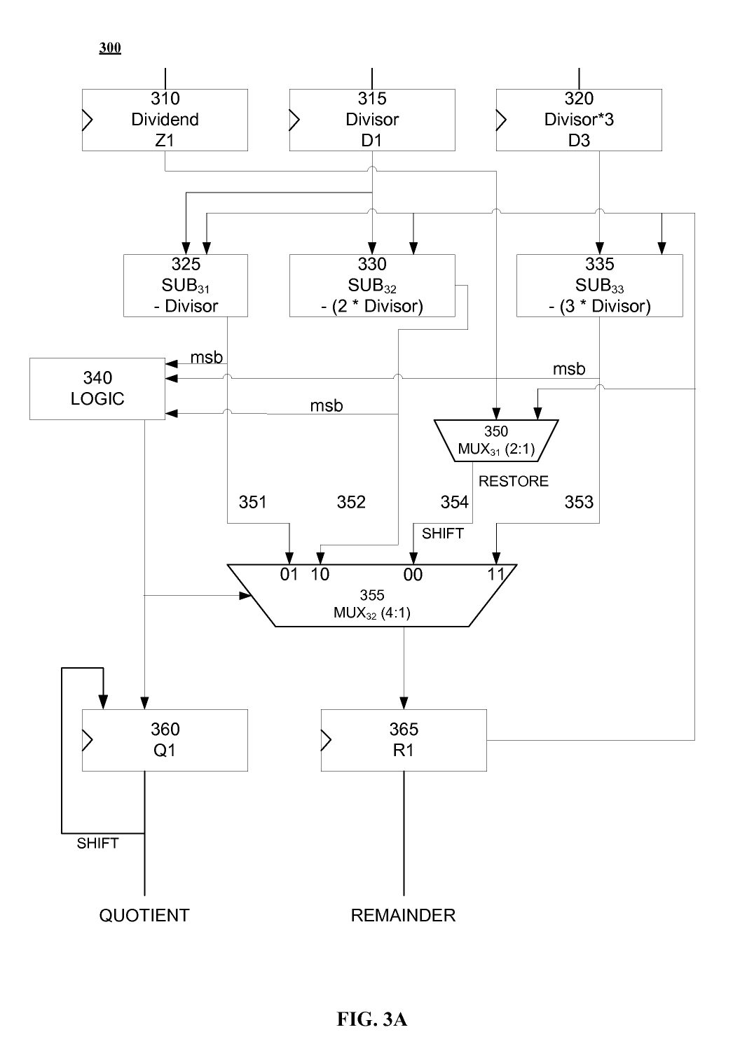

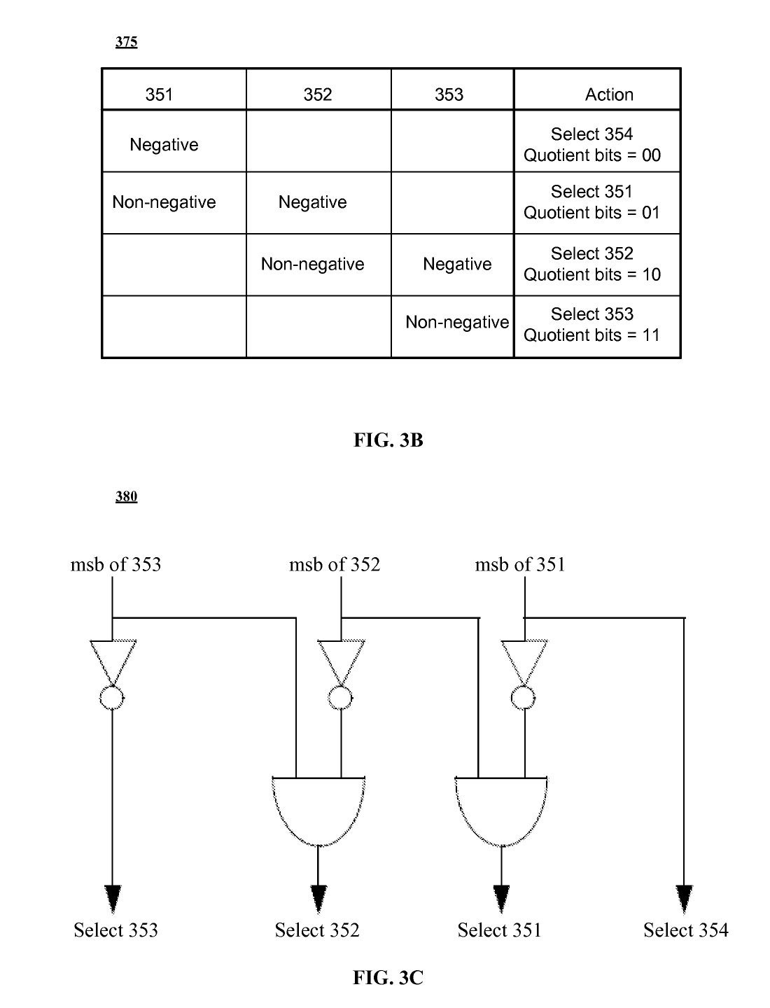

FIG. 3A shows an exemplary circuit 300, consistent with disclosed embodiments for implementing fast restoring integer division. In FIG. 3A, some logic elements such as shifters etc, have not been shown to simplify discussion. In some embodiments, circuit 300 may form part of ALU 115 and/or Fast Integer Divider 120.

As shown in FIG. 3A, the dividend and divisor may be held initially in register Z1 310 and register D1 315, respectively. Further, register D3 320 may hold three times the divisor shown as Divisor*3 in FIG. 3A. For example, in some embodiments, the value Divisor*3 in register D3 320 may be obtained by shifting the divisor left one bit to obtain two times the divisor, which is added to the divisor to obtain Divisor*3.

As shown in FIG. 3A, in circuit 300, 2:1 multiplexer MUX₃₁ 350 is coupled to register Z1 310, and to register R1 365. Register R1 365 is initialized with the dividend and holds the current partial remainder during operation. In circuit 300, during initialization, the dividend in register Z1 310 may be loaded into register R1 365 by selecting appropriate inputs in 2:1 multiplexer MUX₃₁ 350 and 4:1 multiplexer MUX₃₂ 355.

Accordingly, after initialization register R1 365 may hold the dividend, register D1 315 may hold the divisor, register D3 320 may hold three times the divisor, and register Q1 360 may be initialized to zero. After initialization, during normal operation 2:1 multiplexer MUX₃₁ 350 may be configured to select register R1 365, which holds the current partial remainder.

Further, in circuit 300, register D1 315, which holds the divisor is coupled to subtractor SUB₃₁ 325 and SUB₃₂ 330, while register D3 320, which holds Divisor*3 is coupled to SUB₃₃ 335, and register R1 365, which holds the current partial remainder is coupled to subtractor SUB₃₁ 325, subtractor SUB₃₂ 330 and subtractor SUB₃₃ 335.

A single adder circuit may be used to implement both adders and subtractors. The term “adder”, as used herein, refers to a circuit that can perform addition and/or subtraction. For example, a subtractor may be implemented using an adder, by representing a first operand (Y) to be subtracted in two's complement form and adding the two's complement form (−Y) of the first operand to a second operand (X) to obtain the subtraction result (X+(−Y))=(X−Y). Thus, a subtractor may also take the form of an adder. As another example, a subtractor may be implemented using an adder, by representing a first operand (Y) to be subtracted in one's complement form and adding the one's complement form (NOT Y) of the first operand to a second operand (X) and a third operand equal to 1 to obtain subtraction result (X+(NOT Y)+1)=(X−Y).

Subtractor SUB₃₁ 325 subtracts the divisor in register D1 315 from the current partial remainder in register R1 365 and outputs subtraction result 351, while subtractor SUB₃₂ 330 subtracts two times the divisor from the current partial remainder in register R1 365 and outputs subtraction result 352, and subtractor SUB₃₃ 335 subtracts 3*Divisor in register D3 320 from the current partial remainder in register R1 365 and outputs subtraction result 353.

In some embodiments, Divisor, 2*Divisor, and 3*Divisor may be represented in two's complements form or one's complement form, and subtractors SUB₃₁ 325, SUB₃₂ 330 and SUB₃₃ 335 may each be replaced by a corresponding adder. In one embodiment, where adders are used, a first adder may add the two's complement representation of the divisor in register D1 315 (or add the one's complement representation of the divisor in register D1 315 and the value of 1) to the current partial remainder in register R1 365 and output result 351, while a second adder may add the two's complement representation of two times the divisor (or add the one's complement representation of the two times the divisor and the value of 1) to the current partial remainder in register R1 365 and output subtraction result 352, and a third adder may add the two's complement representation of 3*Divisor in register D3 320 (or add the one's complement representation of the 3*Divisor in register D3 320 and the value of 1) to the current partial remainder in register R1 365 and output result 353.

The results 351, 352 and 353 of the subtraction obtained by subtractors SUB₃₁ 325, SUB₃₂ 330, and SUB₃₃ 335, respectively, are output to 4:1 multiplexer MUX₃₂ 355. The current partial remainder register R1 365 shifted left is also input to MUX₃₂ 355.

Further, the most significant bits of outputs 351, 352 and 353 are input to LOGIC block 340. The output of LOGIC block 340 may serve as a select signal for 4:1 multiplexer MUX₃₂ 355, which selects one of 351, 352, 353 or 354. The output of MUX₃₂ 355 is input to register R1 365.

In addition, the output of LOGIC block 340 is input to register Q1 360, which holds the partial quotient. Register Q1 is shifted left by two bits each iteration, and the bits output by LOGIC block 340 are concatenated with the previous value in Q1 360.

LOGIC block 340 uses the most significant bit for each of outputs 351, 352 and 353 to determine which of subtractions resulted in negative values. In some embodiments, logic block 340 may be implemented using combinational logic.

FIG. 3B shows a table illustrating a portion of the logic associated with block 340 shown in the exemplary circuit in FIG. 3A. FIG. 3B also shows actions taken based on the msbs of outputs 351, 352 and 353.

As shown in FIG. 3B, if 351 is negative (the msb of 351=1), then the current partial remainder 354 (input 00₂ to MUX₃₂ 355) is selected and shifted to become the new remainder and the next two quotient bits are 00.

If 351 is non-negative and 352 is negative (msb of 351=0 and msb of 352=1), then 351 (input 01₂ to MUX₃₂ 355) is selected and becomes the new remainder and the next two quotient bits are 01.

If 352 is non-negative and 353 is negative (msb of 352=0 and msb of 353=1), then 352 (input 10₂ to MUX₃₂ 355) is selected and becomes the new remainder and the next two quotient bits are 10.

Finally, if 353 is non-negative (the msb of 353=0), then 353 (input 11₂ to MUX₃₂ 355) is selected and becomes the new remainder and the next two quotient bits are 11. In all of the above instances, the quotient bits are concatenated with the previously determined quotient bits to obtain the new partial quotient.

FIG. 3C shows an exemplary circuit 380 to implement the logic shown in FIG. 3B. As shown in FIG. 3C, when 351 is negative, then msb of 351=1. Also, msb of 352=1 and msb of 353=1. Thus, in the output of circuit 380, select 354 is 1 [select 354=msb of 351], and select 354=select 351=select 352=0.

In circuit 380, if 351 is non-negative and 352 is negative, then msb of 351=0, msb of 352=1, and msb of 353=1. Thus, in the output of circuit 380, select 351=1 [select 351=(NOT(msb of 351)) AND (msb of 352)=1] and select 353=select 352=select 354=0.

Further, in circuit 380, if 352 is non-negative and 353 is negative, then, msb of 352=0, msb of 353=1, and msb of 351=0. Thus, in the output of circuit 380, select 352=1 [select 352=(NOT(msb of 352)) AND (msb of 353)=1] and select 353=select 351=select 354=0.

In circuit 380, if 353 is non-negative, then, msb of 353=0. Also, msb of 351=0, and msb of 352=0. Thus, in the output of circuit 380, select 353=1 [select 353=NOT(msb of 353)] and select 352=select 351=select 354=0.

In some embodiments, circuit 380 may be used to drive select signals Select 351, Select 352, Select 353 and Select 354, which may be used to select the appropriate input in multiplexer 355. Note that the logic for each select signals is based on no more than a pair of msbs output by a corresponding pair of neighboring subtractors. Therefore, the logic may be scaled easily if more than two quotient bits are desired each iteration. In some embodiments, quotient bits may also be derived from the msbs of 351, 352, 353 and 354 and the quotient bits may be concatenated with the previously determined quotient bits to obtain the new (partial) quotient.

A counter or other logic may be used to determine the number of iterations needed and to determine when the division is complete. At the end of the division, register Q1 360 holds the quotient and register R1 365 the final remainder.

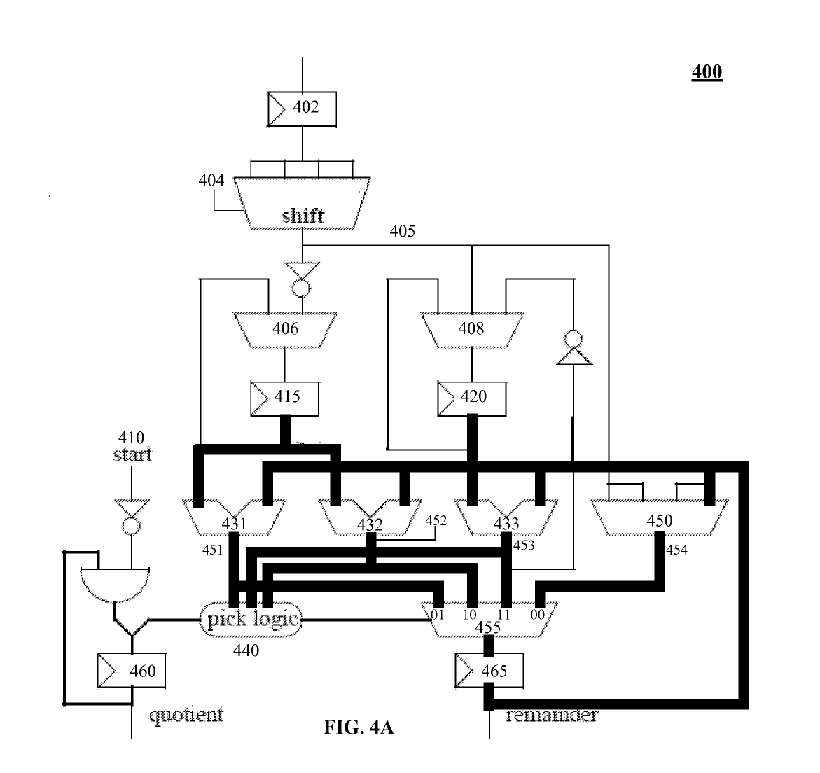

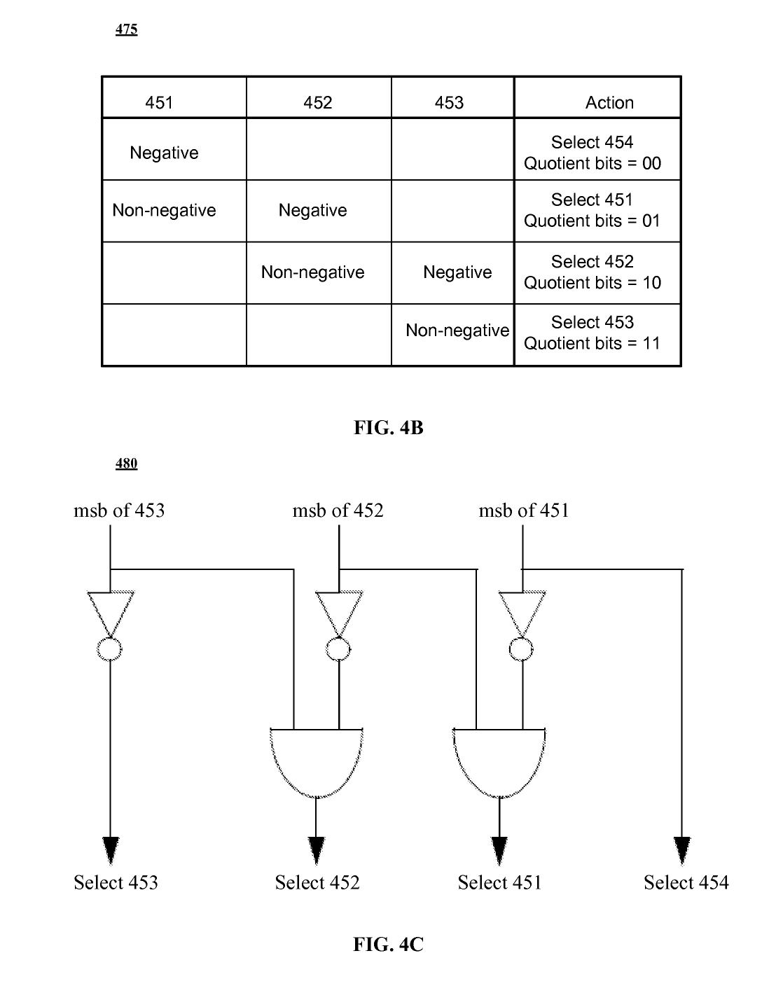

FIG. 4A shows another exemplary circuit 400, consistent with disclosed embodiments for implementing fast restoring integer division. Exemplary circuit 400 uses restoring division and produces 2 quotient bits per cycle. In FIG. 4A, some logic elements may have not been shown to simplify discussion. In some embodiments, circuit 400 may form part of ALU 115 and/or Fast Integer Divider 120.

In some embodiments, initialization may be performed prior to starting division. For example, if the divisor and/or dividend are negative, then the divisor and/or dividend may be complemented. In addition, the divisor and dividend may be normalized by shifting to remove leading zeroes. In some embodiments, based on the normalizing shift amounts, the number of iterations needed may be determined and a counter may be initialized.

Further, in some embodiments, circuit 400 may include elements to provide quick results for the special cases where: the divisor or dividend is zero, the divisor is larger than the dividend, or the divisor is a power of 2. In some embodiments, shifter 404 may be used, at least in part, to perform the normalization of the dividend/divisor and/or perform division when the divisor is a power of 2.

In instances, when the divisor is a power of 2, quick results may be provided using shift operations. For example, for the division of 23115₁₀ by 16₁₀—which may be written as 16-bit numbers in binary as 0101101001001011₂/0000000000010000₂, the divisor may be identified as a power of two because it has exactly one bit with the value of 1.

For division, the dividend may be right shifted by the number of zeroes to the right of the single “1” bit in the divisor. Accordingly, 0101101001001011₂ may be right shifted by 4 bits to obtain 0000010110100100₂. The last four bits 1011₂, which have been shifted out form the remainder. The quotient for the example above is 0000010110100100₂ and the remainder after alignment is 0000000000001011₂.

In another instance, where the dividend is 0 and the divisor is non-zero, the Quotient and Remainder may both be set to 0 (i.e. Quotient=Remainder=0).

Further, when the absolute value of the divisor is greater than the absolute value of the dividend, the quotient may be set to 0, and the remainder may be set to the input dividend (i.e. Quotient=0 and Remainder=Dividend). For example, when the number of leading zeroes in the absolute value of the divisor is greater than the number of leading zeroes in the absolute value of the dividend, then the quotient may be set to 0, and the remainder may be set to the input dividend (i.e. Quotient=0 and Remainder=Dividend).

In some embodiments, one or more of the operations described above may be performed during an initialization phase and/or separately from the flow described below.

In circuit 400 in FIG. 4A, the divisor and/or dividend may be initially loaded into register 402 at appropriate times during the initialization phase. For example, in one embodiment, the divisor may flow ahead of the dividend during initialization. During initialization, in one embodiment, when the divisor is in register 402, shifter 404, which is coupled to register 402, may be used to normalize the divisor by removing leading zeroes. A count of the number of leading zeroes removed during normalization of the divisor may be maintained.

After normalization of the divisor, the divisor is complemented for later use in subtraction in adders 431 and 432. Further, the divisor is routed through multiplexers 408, 450 and 455 to registers 420 and 465. Shifter output 405 (representing 2*Divisor) may be loaded in to register 420. Adder 433 may be used to add the normalized divisor in register 465 to 2*Divisor in register 420 to obtain three times the normalized divisor. Adder 433 output 453 (representing three times the divisor) is negated and routed back to register 420 through multiplexer 408.

Further, during initialization, in one embodiment, when the dividend is in register 402, shifter 404, which is coupled to register 402, may be used to normalize the dividend. A count of the number of leading zeroes removed during normalization of the dividend may be maintained. In some embodiments, the difference between the count of leading zeroes in the divisor and the count of leading zeroes in the dividend may be obtained. Half of the difference between the leading zero counts, plus one, represents the number of iterations to be executed. In addition, the least significant bit (lsb) of the difference may be used to determine if the dividend should be shifted one position to the right (in multiplexer 450) so that an even number of quotient bits is produced. The normalized dividend (possibly shifted) may then be loaded into register 465 as the initial value of the current partial remainder. During operation, register 465 holds the current partial remainder.

Further, multiplexer 450, which is coupled to shifter 404, may be configured to select shifter output 405 (representing the normalized dividend) and multiplexer 455 may be configured to select multiplexer 450 output 454 (the normalized dividend), which is then loaded into register 465.

In FIG. 4A, the heavy lines indicate paths in the circuit that are active when performing restoring division that produces 2 quotient bits per cycle. After initialization, register 415 holds the complement of the divisor, register 420 holds the complement of (3*Divisor), and register 465 holds the dividend as the initial current partial remainder. Register 460 is initialized to zero.

Further, in circuit 400, register 415, which holds the divisor, is coupled to adders 431 and 432, while register 420, which holds the complement of (3*Divisor) is coupled to adder 433, and register 465, which holds the current partial remainder is coupled to adders 431, 432, and 433.

Adder 431 subtracts the divisor in register D1 315 from the current partial remainder in register 465 and outputs subtraction result 451, while adder 432 subtracts two times the divisor from the current partial remainder in register 465 and outputs subtraction result 452, and adder 433 subtracts 3*Divisor in register 420 from the current partial remainder in register 465 and outputs subtraction result 453.

The results 451, 452 and 453 of the subtraction obtained by adders 431, 432 and 433, respectively, are output to 4:1 multiplexer 455. The current partial remainder register 465 shifted left is also input to multiplexer 455.

Further, the most significant bits of outputs 451, 452 and 453 are input to pick logic block 440. The output of pick logic block 440 may serve as a select signal for 4:1 multiplexer 455, which selects one of 451, 452, 453 or 454. The output of multiplexer 455 is input to register 465.

In addition, the output of pick logic block 440 is input to register 460, which holds the partial quotient. Register 460 is shifted left by two bits each iteration, and the bits output by pick logic block 440 are concatenated with the previous value in register 460.

Pick logic block 440 uses the most significant bit for each of outputs 451, 452 and 453 to determine which of subtractions resulted in negative values. In some embodiments, pick logic block 440 may be implemented using combinational logic.

FIG. 4B shows a table illustrating a portion of the logic that may be associated with pick logic block 440 shown in the exemplary circuit in FIG. 4A. FIG. 4B also shows actions taken based on the msbs of outputs 451, 452 and 453.

As shown in FIG. 4B, if 451 is negative (the msb of 451=1), then the current partial remainder 454 (input 00₂ to multiplexer 455) is selected and shifted to become the new remainder and the next two quotient bits are 00.

If 451 is non-negative and 452 is negative (msb of 451=0 and msb of 452=1), then 451 (input 01₂ to multiplexer 455) is selected and becomes the new remainder and the next two quotient bits are 01.

If 452 is non-negative and 453 is negative (msb of 452=0 and msb of 453=1), then 452 (input 10₂ to multiplexer 455) is selected and becomes the new remainder and the next two quotient bits are 10.

Finally, if 453 is non-negative (the msb of 453=0), then 453 (input 11₂ to multiplexer 455) is selected and becomes the new remainder and the next two quotient bits are 11. In all of the above instances, the quotient bits are concatenated with the previously determined quotient bits to obtain the new (partial) quotient.

FIG. 4C shows an exemplary circuit 480 to implement the logic shown in FIG. 4B. As shown in FIG. 4C, when 451 is negative, then msb of 451=1. Also, msb of 452=1 and msb of 453=1. Thus, in the output of circuit 480, select 454 is 1 [select 454=msb of 451] and select 454=select 451=select 452=0.

In circuit 480, if 451 is non-negative and 452 is negative, then msb of 451=0, msb of 452=1, and msb of 453=1. Thus, in the output of circuit 480, select 451=1 [select 451=(NOT(msb of 451)) AND (msb of 452)=1] and select 453=select 452=select 454=0.

Further, in circuit 480, if 452 is non-negative and 453 is negative, then, msb of 452=0 and msb of 453=1 (and msb of 451=0). Thus, in the output of circuit 480, select 452=1 [select 452=(NOT(msb of 452)) AND (msb of 453)=1] and select 453=select 451=select 454=0.

In circuit 480, if 453 is non-negative, then, msb of 453=0. Also, msb of 451=0, and msb of 452=0. Thus, in the output of circuit 480, select 453=1 [select 453=NOT(msb of 453)] and select 452=select 451=select 454=0.

In some embodiments, circuit 480 may be used to drive select signals Select 451, Select 452, Select 453 and Select 454, which may be used to select the appropriate input in multiplexer 455. In some embodiments, quotient bits may also be derived from the msbs of 451, 452, 453 and 454 and the quotient bits may be concatenated with the previously determined quotient bits to obtain the new (partial) quotient.

A counter or other logic may be decremented with the completion of each iteration, and may be used to determine when the division is complete. At the end of the division, quotient register 460 holds the final quotient and register 465 the final remainder.

Note that the exemplary circuits shown in FIGS. 3A and 4A obtain two-bits for each iteration. However, these circuits may be easily be extended to produce m bits per iteration where m>2. For example, to produce 3 bits per iteration, seven subtractions may be performed using 7 adders/subtractors, and logic blocks 340/440 may be appropriately altered to select the appropriate subtraction result as the next current partial remainder and determine the three quotient bits based on which of the seven subtraction results were negative/non-negative. For example, the seven subtractions at each iteration would be R−D, R−2D, R−3D, R−4D, R−5D, R−6D, and R−7D, where “R” is the current partial remainder and D is the current divisor. Further, because the logic for the select signals is based on no more than a pair of msbs (output by a corresponding pair of neighboring subtractors/adders), the select logic may be scaled easily if more than two quotient bits are desired for each iteration.

Further the initialization process may be altered. For example 2D and 4D may be computed by shifting D left. Further, 3D may be computed by adding D and 2D, and 6D may be obtained by shifting 3D left 1 bit. In addition, 5D may be computed as 5D=D+4D, while 7D may be computed as 7D=D+2D+4D. For example, 7D may be computed as one add followed by another, or one carry save adder using full adders and then adding that result with a carry look ahead adder.

Further, multiplexers 355/455 may be altered to be an 8:1 multiplexer or two 4:1 multiplexers followed by a 2:1 multiplexer, to select one of the 7 subtraction results or the current partial remainder from the last iteration.

In general, to produce m quotient bits per iteration, 2^{m}−1 adders/subtractors may be used to compute R−i*D, for 1≦i≦2^{m}−1. For example, each adder/subtractor i may compute R−i*D. In addition, the adders may be used during initialization to compute the products i*D, for 1≦i≦2^{m}−1. Further, the logic block corresponding to 340/440 may be altered based on the values of the 2^{m}−1 msbs, and the multiplexer corresponding to 355/455 may be altered to be a 2^{m}:1 multiplexer, or an equivalent sequence of smaller multiplexers. The number of quotient bits determined at each iteration may be based on design considerations, such as the initialization overhead, available area, speed desired, the likely sizes of the integer operands, and other design parameters. In some embodiments, logic block 340/440 may be replaced with an on-chip or cached look up table.

In addition, for a circuit producing m quotient bits per iteration with 2^{m}−1 adders, where adder i computes R−i*D, a plurality of 2^{m-1} registers may be used to hold multiples of the divisors D. For example, each register j may: (i) hold a value given by (2j−1)*D, where 1≦j≦2^{m-1}. Further, each register j may be coupled to the input of all adders q, where q=(2j−1)*2^{k}, 1≦q≦2^{m}−1 and 0<k≦(m−1).

Accordingly, for the example above, where m=3 and 3 quotient bits per iteration are computed, an exemplary circuit may comprise 2^{m-3}−1=7 adders, where an adder i computes R−iD, where “R” is the current partial remainder and D is the current divisor. Thus, the seven adders i (for 1≦i≦7) would perform seven subtractions at each iteration and compute R−D, R−2D, R−3D, R−4D, R−5D, R−6D, and R−7D, respectively. Further, the circuit may comprise a plurality of 2^{m-1}=2³⁻¹=4 registers, which may be used to hold multiples of the divisors D. For example, each register j may: (i) hold a value given by (2j−1)*D, where 1≦j≦2^{m-1}. Accordingly, register 1 (j=1) would hold the value (2j−1)D=[2(1)−1]D=D. Similarly, register j=2 would hold the value 3D, register 3 would hold the value 5D and register 4 would hold the value 7D.

Further, each register j may be coupled to the input of all adders q, where q=(2j−1)*2^{k}, 0≦q≦2^{m}−1 and 0<k≦(m−1Accordingly, register 1(j=1) would be coupled to: for k=0, adder [(2j−1)*2^{k-0}]=adder[1*2⁰]=adder 1; for k=1, adder[1*2¹]=adder 2 and for k=2, adder[1*2²]=adder 4.

Similarly, register 2 (j=2) would be coupled to: for k=0, adder [(2j−1)*2^{k-0}]=adder[3*2⁰]=adder 3; and for k=1, adder[3*2¹]=adder 6. Note that for the case k=2, q=(3)(4)=12 so that the constraint q<2^{m-3}−1 or q≦7 is not satisfied because 12>7, therefore values of k greater than 1 are not considered for register 2 and above.

Similarly, register 3 (j=3) would be coupled to: for k=0, adder [(2j−1)*2^{k=0}]=adder[5*2⁰]=adder 5; while register 4 (j=4) would be coupled to: for k=0, adder [(2j−1)*2^{k=0}]=adder[7*2⁰]=adder 7. Note that for k=1, q>7, therefore the value of k=1 is also not considered for j=3 and j=4. Thus, as illustrated above, the exemplary circuits may be extended and/or modified in various ways to generate m quotient bits per iteration.

In some embodiments, a plurality of fast integer dividers producing multiple quotient bits per iteration consistent with disclosed embodiments may form part of Single Instruction Multiple Data (SIMD) processor, which may be configured to execute integer divide and modulus instructions for both signed and unsigned operands. For example, an SIMD processor, which includes a plurality of fast integer dividers that produce multiple bits per quotient, may be configured to execute one double word (64 bit) computation, two word (32 bit) computations, four half word (16 bit) computations, or eight byte (8 bit) computations in parallel. In another implementation, specific instructions may be provided for a processor including a fast integer divider consistent with disclosed embodiments and the instructions may trigger use of the fast integer divider circuit.

In instances, when more than one computation is performed in parallel, the results obtained earlier may be held until all the results are available and then a completion signal (div finishing soon) may be provided. The resulting values may be maintained for retrieval until the next divide or module request is made. For example the completion signal div finishing soon may be set to 1, some number of (e.g. 5) clock cycles prior to when the results are known to be available. The completion signal div finishing soon may be forwarded to other operations.

Although the description includes illustrative examples in connection with specific embodiments, the disclosure is not limited thereto. Various adaptations and modifications may be made without departing from the scope. Therefore, the spirit and scope of the appended claims should not be limited to the foregoing description.

What is claimed is:

1. An integer divide circuit to divide a dividend by a divisor (D) and produce m quotient bits per iteration, where m≧2, the circuit comprising:
a partial remainder register, initialized with the dividend, to hold a current partial remainder (R);
a plurality (2^{m}−1) of adders coupled to the partial remainder register, each adder i to output a corresponding subtraction result R−i*D, where 1≦i≦2^{m}−1; and
a logic block coupled to the plurality of adders, wherein, the logic block determines m quotient bits based, at least in part, on the 2^{m}−1 subtraction results.

2. The integer divide circuit of claim 1, wherein :
the logic block is configured to determine m quotient bits based on the most significant bits of the 2^{m}−1 subtraction results.

3. The integer divide circuit of claim 1, further comprising:
a quotient register, the quotient register coupled to the logic block, wherein the m quotient bits are used to update the quotient register by concatenating the m quotient bits to the current value in the quotient register.

4. The integer divide circuit of claim 1, further comprising:
at least one multiplexer comprising a select input coupled to the logic block, and with inputs coupled to the plurality of adders and to the partial remainder register, wherein the m quotient bits select either the partial remainder register or one of the 2^{m}−1 subtraction results, and
wherein the selected multiplexer input is used to update the partial remainder register.

5. The integer divide circuit of claim 1, further comprising:
a plurality (2^{m-1}) of registers, wherein each register j in the plurality:
holds a value given by (2j−1)*D, where 1≦j≦2^{m-1}, and is coupled to the input of those adders i, for which the
conditions i=(2j−1)*2^{k} for 0<k≦(m−1) and
1≦(2j−1)*2^{k}≦2^{m}−1 are true.

6. The integer divide circuit of claim 1, wherein:
m=2, and the at least one multiplexer comprises a 4:1 multiplexer, or
m=3, and the at least one multiplexer comprises an 8:1 multiplexer.

7. The integer divide circuit of claim 1, further comprising:
a shifter, to normalize the dividend and divisor by removing leading zeroes from the dividend and divisor prior to division, and
a counter initialized with a number of iterations to be performed, wherein the number of iterations is given by half of the absolute value of the difference between the count of leading zeroes in the divisor and the count of leading zeroes in the dividend, plus one.

8. A processor comprising an integer divide unit to produce m quotient bits per iteration, where m≧2, and wherein the integer divide unit further comprises:
a partial remainder register, initialized with a dividend, to hold a current partial remainder (R);
a plurality (2^{m}−1) of adders coupled to the partial remainder register, each adder i to output a corresponding subtraction result R−i*D, where D is the divisor and 1≦i≦2^{m}−1; and
a logic block coupled to the plurality of adders, wherein, the logic block is configured to determine m quotient bits based, at least in part, on the 2^{m}−1 subtraction results.

9. The processor of claim 8, wherein:
the logic block is configured to determine m quotient bits based on the most significant bits of the 2^{m}−1 subtraction results.

10. The processor of claim 8, wherein the integer divide unit further comprises:
a quotient register, the quotient register coupled to the logic block, wherein the m quotient bits are used to update the quotient register by concatenating the m quotient bits to the current value in the quotient register.

11. The processor of claim 8, wherein the integer divide unit further comprises:
at least one multiplexer comprising a select input coupled to the logic block, and with inputs coupled to the 2^{m}−1 adders and to the partial remainder register, wherein the m quotient bits select either the partial remainder register or one of the 2^{m}−1 subtraction results, and
wherein the selected multiplexer input is used to update the partial remainder register.

12. The processor of claim 8, wherein the integer divide unit further comprises:
a plurality (2^{m-1}) of registers, wherein each register j in the plurality:
holds a value given by (2j−1)*D, where 1≦j≦2^{m-1}, and is coupled to the input of those adders i, for which the
conditions i=(2j−1)*2^{k} for 0<k≦(m−1) and
1≦(2j−1)*2^{k}≦2^{m}−1 are true.

13. The processor of claim 8, wherein:
m=2, and the at least one multiplexer comprises a 4:1 multiplexer, or
m=3, and the at least one multiplexer comprises an 8:1 multiplexer.

14. The processor of claim 8, wherein the integer divide unit further comprises:
a shifter, to normalize the dividend and divisor by removing leading zeroes from the dividend and divisor prior to division, wherein a number of iterations to be performed is given by half of the absolute value of the difference between the count of leading zeroes in the divisor and the count of leading zeroes in the dividend, plus one.

15. A non-transitory computer-readable medium comprising executable instructions to describe an integer divide circuit to divide a dividend by a divisor (D) and produce m quotient bits per iteration, where m≧2, the integer divide circuit comprising:
a partial remainder register, initialized with the dividend, to hold a current partial remainder (R);
a plurality (2^{m}−1) of adders coupled to the partial remainder register, each adder i to output a corresponding subtraction result R−i*D, where 1≦i≦2^{m}−1; and
a logic block coupled to the plurality of adders, wherein, the logic block is configured to determine m quotient bits based, at least in part, on the 2^{m}−1 subtraction results.

16. The computer-readable medium of claim 15, wherein:
the logic block is configured to determine m quotient bits based on the most significant bits of the 2^{m}−1 subtraction results.

17. The computer-readable medium of claim 15, wherein the integer divide circuit further comprises:
a quotient register, the quotient register coupled to the logic block, wherein the m quotient bits are used to update the quotient register by concatenating the m quotient bits to the current value in the quotient register.

18. The computer-readable medium of claim 15, wherein the integer divide circuit further comprises:
at least one multiplexer comprising a select input coupled to the logic block, and with inputs coupled to the 2^{m}−1 adders and to the partial remainder register, wherein the m quotient bits select either the partial remainder register or one of the 2^{m}−1 subtraction results, and
wherein the selected multiplexer input is used to update the partial remainder register.

19. The computer-readable medium of claim 15, wherein the integer divide circuit further comprises:
a plurality (2^{m-1}) of registers, wherein each register j in the plurality:
holds a value given by (2j−1)*D, where 1≦j≦2^{m-1}, and
is coupled to the input of those adders i, for which the
conditions i=(2j−1)*2^{k} for 0<k≦(m−1) and
1≦(2j−1)*2^{k}≦2^{m}−1 are true.

20. The computer-readable medium of claim 15, wherein:
m=2, and the at least one multiplexer comprises a 4:1 multiplexer, or
m=3, and the at least one multiplexer comprises an 8:1 multiplexer.
